(19) United States
(12) Patent Application Publication
(10) Pub. No.: US 2026/0039217 A1
(43) Pub. Date: Feb. 5, 2026

(54) POWER SEMICONDUCTOR MODULE AND MOTOR DRIVE SYSTEM USING SAME

(71) Applicant: Minebea Power Semiconductor Device Inc., Ibaraki (JP)

(72) Inventors: Daisuke IKARASHI, Tokyo (JP); Toru MASUDA, Tokyo (JP); Yuuichi MABUCHI, Tokyo (JP); Yuji TAKAYANAGI, Hitachi-shi (JP)

(21) Appl. No.: 18/997,545

(22) PCT Filed: Mar. 30, 2023
(86) PCT No.: PCT/JP2023/013093

§ 371 Date: Jan. 22, 2025

(30) Foreign Application Priority Data
Jul. 25, 2022 (JP) 2022-117792

(51) Int. Cl. H02M 7/00; H02M 1/34

(52) U.S. Cl. CPC H02M 7/003; H02M 1/346

(57) ABSTRACT

In a power semiconductor module including a snubber capacitor, the power semiconductor module capable of achieving both a high current density and prevention of heating of the snubber capacitor is provided. The power semiconductor module includes: a positive electrode terminal; a negative electrode terminal of which at least a part is disposed to overlap the positive electrode terminal in a plan view; a first wiring branching from the positive electrode terminal; a second wiring branching from the negative electrode terminal; and a snubber capacitor disposed outside of a position at which the positive electrode terminal and the negative terminal overlap each other in the plan view and connected through the first wiring and the second wiring.

### TECHNICAL FIELD

The present invention relates to a structure of a power semiconductor module, and more particularly, to a technology that is effective for an application to a power semiconductor module including a snubber capacitor.

### BACKGROUND ART

A power converting device has functions such as AC-DC conversion and DC-AC conversion of power or frequency conversion of AC power, voltage conversion of DC power, and the like. In order to achieve such conversion functions, the power converting device includes a power converting circuit that converts power using on/off operations of a power semiconductor module having a switching function.

Inside the power semiconductor module, an insulating substrate in which a wiring pattern is formed is bonded on a metal base for heat dissipation by using solder or the like. There are forms such as a 1-in-1 module in which a single switching element (a semiconductor element) or a plurality of switching elements connected in parallel are mounted on the wiring pattern of the insulating substrate, a 2-in-1 module in which two switching elements are connected in series inside the module and in which a half bridge circuit is configured using one module, and the like.

In recent years, due to improvement in the performance of switching elements, reductions in conduction losses through low on-resistance or low on-voltage and reductions in switching losses through high-speed switching have progressed. In addition, in accompaniment with low losses of switching elements, implementation of a high current density inside of a power semiconductor module due to an increase in the rated current of a power semiconductor module has progressed. In a case in which the rated current and the switching speed of a power semiconductor module are increased, di/dt at the time of turn-off switching increases, and a surge voltage at the time of turn-off switching, which is in proportion to di/dt and wiring inductance of a main circuit, increases.

Here, for example, in the case of a half bridge circuit, the wiring inductance of a main circuit is the wiring inductance of single circulation loop of a power conversion main circuit returning to a DC smoothing capacitor from the DC smoothing capacitor through a switching element of an upper-arm and a switching element of a lower-arm. When a surge voltage exceeds the rated voltage of a power semiconductor module, there is concern that an overvoltage failure may occur, and thus the surge voltage needs to be suppressed to be the rated voltage or less.

In order to reduce the surge voltage with di/dt maintained, the wiring inductance of a main circuit may be reduced. However, there is a limitation on reduction in the wiring inductance of the main circuit by changing the wiring structure of the inside of a power converting circuit and a power semiconductor module.

As a method for reducing the surge voltage other than the method of changing the wiring structure of the inside of the module, for example, in the case of a 2-in-1 module, there is a method in which a snubber capacitor is connected between a positive electrode terminal and a negative electrode terminal of the inside of the power semiconductor module. By mounting a snubber capacitor inside a power semiconductor module and disposing it in close proximity to switching elements of upper and lower arms, the wiring inductance of the main circuit decreases for a current flowing through the snubber capacitor at the time of turn-off switching, and thus the surge voltage can be reduced.

Although the snubber capacitor may be mounted on an insulating substrate disposed on a metal base of the inside of a power semiconductor module, in that case, a mounting space of switching elements is decreased to the extent that the snubber capacitor is mounted, which becomes a hindrance in a case in which the power semiconductor module is desired to have a high power density by increasing the number of mounted switching elements.

As a background technology of this technical field, for example, there is a technology as described in Patent Literature 1. In Patent Literature 1, a method for achieving both a high power density of a power semiconductor module and suppression of a surge voltage by a built-in snubber capacitor by employing a structure in which the snubber capacitor is interposed between a positive electrode terminal and a negative electrode terminal of the inside of the power semiconductor module has been proposed.

### CITATION LIST

### Patent Literature

Patent Literature 1: Japanese Patent Application Publication No. 2020-120455

### SUMMARY OF INVENTION

### Technical Problem

However, in Patent Literature 1 described above, since a structure in which a snubber capacitor is interposed between a positive electrode terminal and a negative electrode terminal is employed, there is concern that the snubber capacitor may be brought into an overheated state due to an increase in the amount of heat dissipation of the positive electrode terminal and the negative electrode terminal accompanying a high current density of recent power semiconductor modules, ultimately leading to a failure.

Thus, an object of the present invention is to provide a power semiconductor module capable of achieving both a high current density and prevention of heating of a snubber capacitor in the power semiconductor module including the snubber capacitor and a motor drive system using the power semiconductor module.

### Solution to Problem

In order to solve the problems described above, the present invention includes: a positive electrode terminal; a negative electrode terminal of which at least a part is disposed to overlap the positive electrode terminal in a plan view; a first wiring branching from the positive electrode terminal; a second wiring branching from the negative electrode terminal; and a snubber capacitor disposed outside of a position at which the positive electrode terminal and the negative electrode terminal overlap each other in the plan view and connected through the first wiring and the second wiring.

### Advantageous Effects of Invention

According to the present invention, a power semiconductor module capable of achieving both a high current density and prevention of heating of a snubber capacitor in the power semiconductor module including the snubber capacitor and a motor drive system using the power semiconductor module can be realized.

Because of this, the present invention can contribute to low losses and improvement of reliability of a power semiconductor module and a motor drive system using the power semiconductor module.

Problems, configurations, and effects other than those described above are disclosed in description of the following embodiments.

### BRIEF DESCRIPTION OF DRAWINGS

FIG. 1 is a cross-sectional view illustrating an internal structure of a power semiconductor module according to Example 1 of the present invention.

FIG. 2 is an enlarged view of a mounting part of a snubber capacitor 14 illustrated in FIG. 1.

FIG. 3 is a diagram conceptually illustrating the flow of a current in FIG. 2.

FIG. 4 is a plan view of the power semiconductor module illustrated in FIG. 1.

FIG. 5 is an equivalent circuit diagram of a half bridge circuit configured using the power semiconductor module illustrated in FIG. 1.

FIG. 6 is a diagram illustrating a simulation result of a switching waveform in the circuit configuration illustrated in FIG. 5 (no snubber capacitor).

FIG. 7 is a diagram illustrating a simulation result of a switching waveform in the circuit configuration illustrated in FIG. 5 (the capacitance of the snubber capacitor: 50 nF).

FIG. 8 is a plan view of a power semiconductor module according to Example 2 of the present invention.

FIG. 9 is an equivalent circuit diagram of a half bridge circuit configured using the power semiconductor module illustrated in FIG. 8.

FIG. 10 is a plan view of a power semiconductor module according to Example 3 of the present invention.

FIG. 11 is a perspective view of a mounting part of a first snubber capacitor 14 and a second snubber capacitor 32 inside of the power semiconductor module illustrated in FIG. 10.

FIG. 12 is an equivalent circuit diagram of the inside of the power semiconductor module illustrated in FIG. 10.

FIG. 13 is a configuration diagram of a motor drive system according to Example 4 of the present invention.

### DESCRIPTION OF EMBODIMENTS

Hereinafter, examples of the present invention will be described with reference to the drawings. In the drawings, the same reference signs are assigned to the same components, and detailed description of duplicate parts will be omitted.

### Example 1

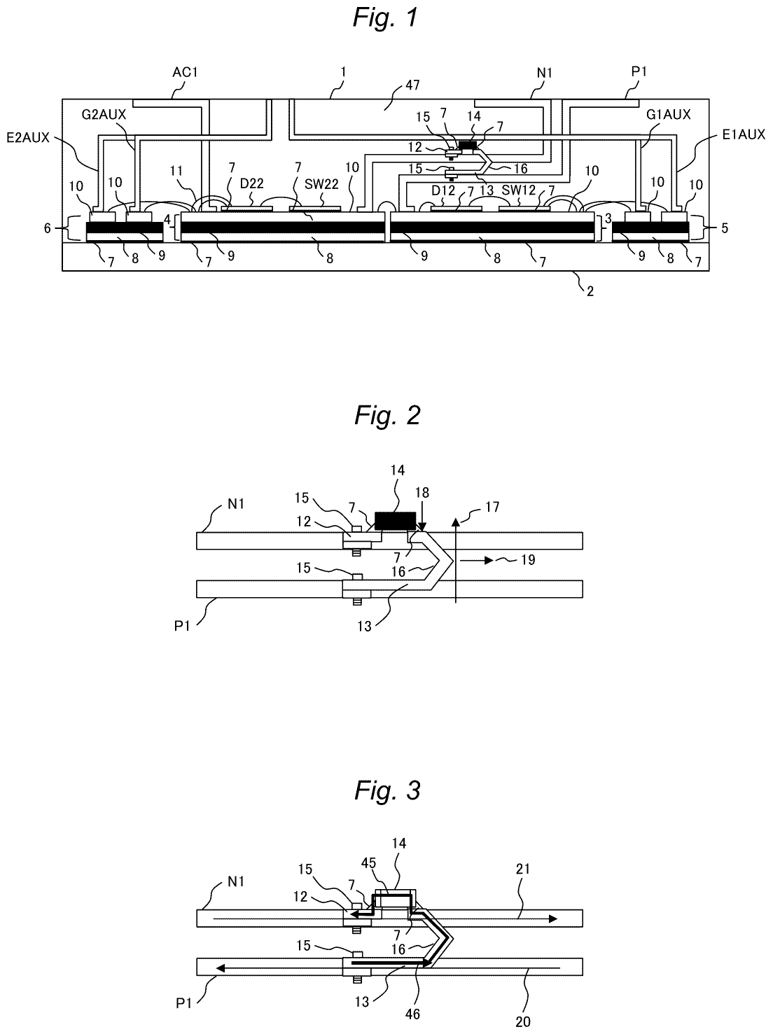

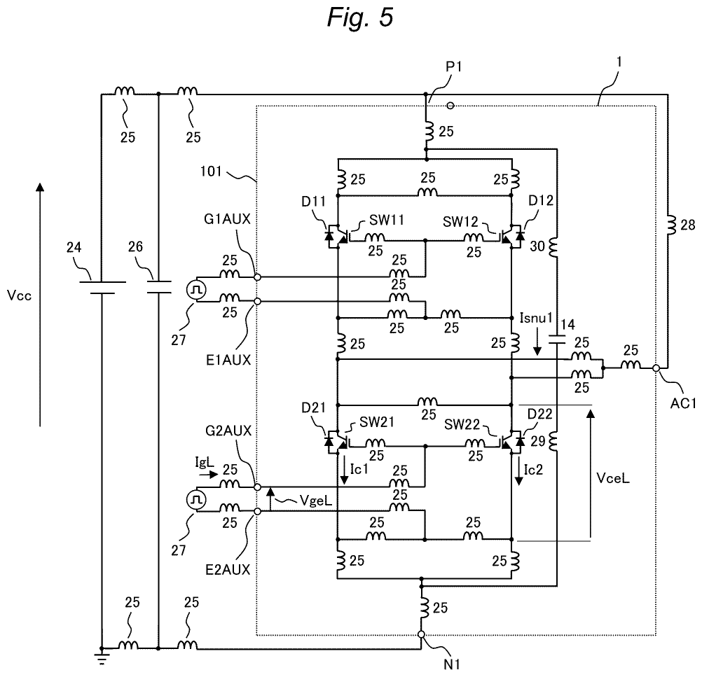

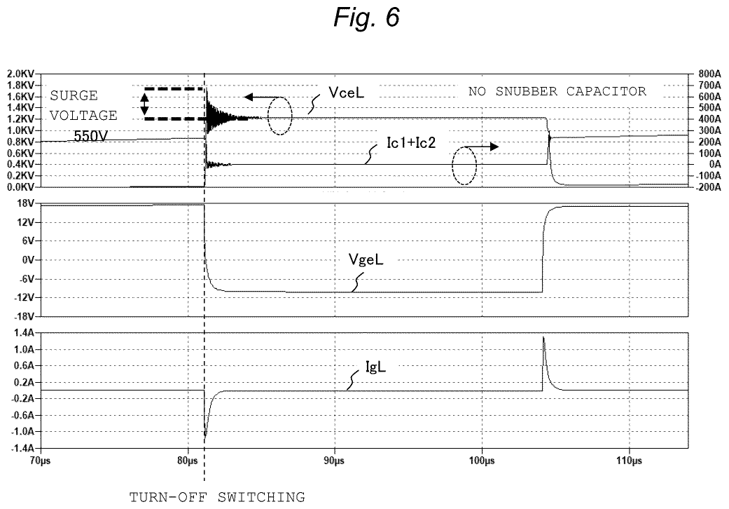

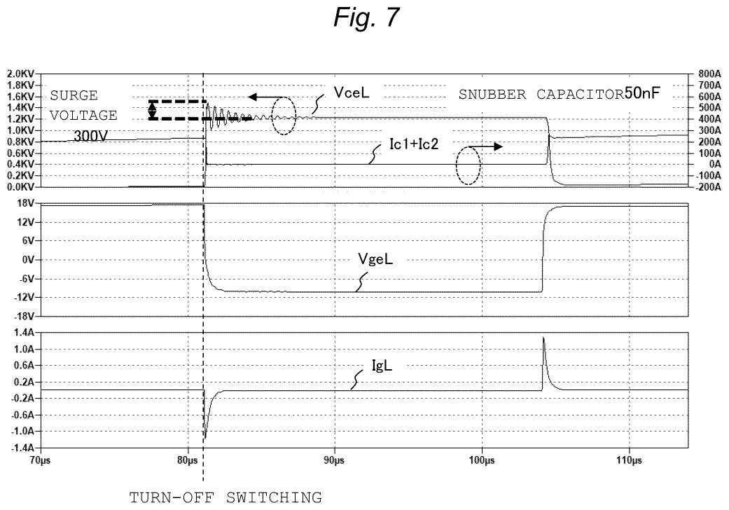

A power semiconductor module according to Example 1 of the present invention will be described with reference to FIGS. 1 to 7. In this example, first, the structure of the power semiconductor module according to this example will be described with reference to FIGS. 1 to 4. Next, an equivalent circuit diagram of a case in which a half bridge circuit is configured using the power semiconductor module according to this example will be described with reference to FIG. 5. Finally, the effect of reduction of a surge voltage at the time of turn-off according to the present invention in the circuit configuration illustrated in FIG. 5 will be described with reference to FIGS. 6 and 7.

FIG. 1 is a cross-sectional view illustrating an internal structure of the power semiconductor module 1 according to this example. The power semiconductor module 1 according to this example is a so-called 2-in-1 module.

As illustrated in FIG. 1, in the power semiconductor module 1 according to this example, an insulating substrate 3 of an upper arm, an insulating substrate 4 of a lower arm, an insulator substrate 5 of an upper arm, and an insulator substrate 6 of a lower arm are bonded using solder 7 on a metal base 2 for heat dissipation. Each of the insulating substrates 3 and 4 and the insulator substrates 5 and 6 is configured using a metal layer 8, an insulating layer 9, and a wiring pattern 10.

On the wiring pattern 10 of the insulating substrate 3 of the upper arm, a switching element SW11 (not shown in FIG. 1), a switching element SW12, a diode D11 (not shown in FIG. 1), and a diode D12 are bonded using solder 7. As a bonding material, a material such as sintered copper or the like other than solder may be used.

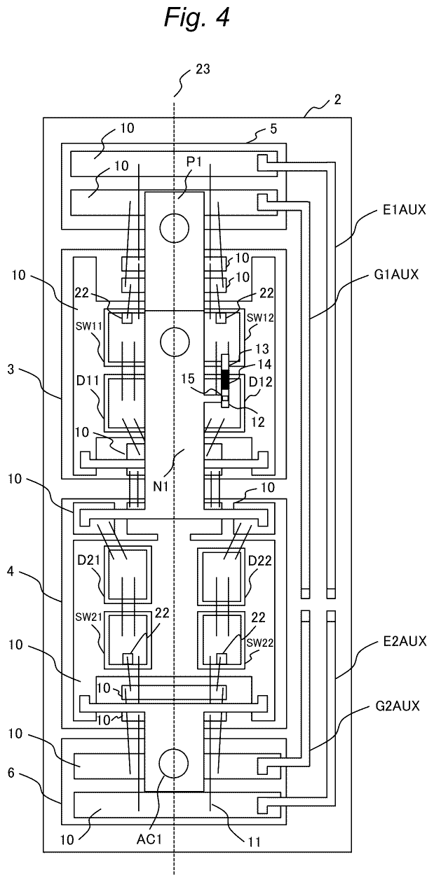

High potential-side electrodes (here, a collector electrode and an anode electrode) of the switching elements SW11 and SW12 and the diodes D11 and D12 are electrically connected using the wiring pattern 10, and low potential-side electrodes (here, an emitter electrode and a cathode electrode) are electrically connected using a bonding wire 11 (see FIG. 4).

On the wiring pattern 10 of the insulating substrate 4 of the lower arm, a switching element SW21 (not shown in FIG. 1), a switching element SW22, a diode D21 (not shown in FIG. 1), and a diode D22 are bonded using solder 7. As a bonding material, a material such as sintered copper or the like other than solder may be used.

High potential-side electrodes (here, a collector electrode and an anode electrode) of the switching elements SW21 and SW22 and the diodes D21 and D22 are electrically connected using the wiring pattern 10, and low potential-side electrodes (here, an emitter electrode and a cathode electrode) are electrically connected using the bonding wire 11 (see FIG. 4).

As each of the switching elements SW11, SW12, SW21, and SW22, in addition to an Insulated Gate Bipolar Transistor (IGBT) illustrated in the drawing, a Metal-Oxide-Semiconductor Field Effect Transistor (MOSFET) or the like is used. In addition, as each of the diodes D11, D12, D21, and D22, in addition to a pn junction diode, a Schottky Barrier Diode (SBD) or the like is used.

A semiconductor material composing the switching elements SW11, SW12, SW21, and SW22 and the diodes D11, D12, D21, and D22 may be either Si or a wide gap semiconductor such as SiC.

In addition, in a case in which a MOSFET is used as each of the switching elements SW11, SW12, SW21, and SW22, a parasitic diode (body diode) of the MOSFET may be used as each of the diodes D11, D12, D21, and D22.

A positive electrode terminal (a first positive electrode terminal) P1 in the insulating substrate 3 of the upper arm, a negative electrode terminal (a first negative electrode terminal) N1 in the insulating substrate 4 of the lower arm, a gate auxiliary terminal G1AUX of an upper arm and an emitter auxiliary terminal E1AUX of an upper arm in the insulator substrate 5 of the upper arm, and a gate auxiliary terminal G2AUX of a lower arm and an emitter auxiliary terminal E2AUX of a lower arm in the insulator substrate 6 of the lower arm are bonded to respective wiring patterns 10 using ultrasonic waves. A bonding method may be another method such as solder bonding. The entire power semiconductor module 1 enters a resin casing (not shown in the drawing), and the inside is sealed using a gel 47. A sealing material may be another material such as a resin.

At least a part of the negative electrode terminal N1 is disposed to overlap the positive electrode terminal P1 in the plan view, and a gap between the two terminals is designed to be very short as long as an insulating distance is secured. This is for decreasing wiring inductance of the two terminals by offsetting magnetic fluxes generated by currents flowing through the terminals by disposing the two terminals through which currents of opposite directions flow to face each other and be in close proximity to each other.

In the present invention, there is a feature that a snubber capacitor (a first snubber capacitor) 14 is connected to the negative electrode terminal N1, which is disposed so as to overlap the positive electrode terminal P1 when seen in the plan view as in FIG. 1, outside a position at which the positive electrode terminal P1 and the negative electrode terminal N1 overlap each other in the plan view through a first bus bar 12 branching from the negative electrode terminal N1 and a second bus bar 13 branching from the positive electrode terminal P1.

In this way, by connecting the snubber capacitor 14 at a position at which the positive electrode terminal P1 and the negative electrode terminal N1 generating heat using a current flow do not overlap each other, in other words, outside a position at which the positive electrode terminal P1 and the negative electrode terminal N1 overlap each other when the power semiconductor module 1 is seen in the plan view, an excessive increase in the temperature of the snubber capacitor 14 due to heating from the positive electrode terminal P1 and the negative electrode terminal N1 can be prevented.

The first bus bar 12 and the negative electrode terminal N1 and the second bus bar 13 and the positive electrode terminal P1 are connected using screws 15. The connection of a bus bar and a terminal may be performed using another method such as solder bonding or the like instead of the screws 15 as long as electric connection is made.

Since the capacitance of the snubber capacitor 14 is in order of several tens of nF to several hundreds of nF and is about 1/1000 or less of the capacitance of a DC smoothing capacitor (not shown in the drawing) connected to the power semiconductor module 1 on the outside, flow currents of the first bus bar 12 and the second bus bar 13 become sufficiently smaller than those of the positive electrode terminal P1 and the negative electrode terminal N1 as well, thus, the amounts of generated heat due to currents for the first bus bar 12 and the second bus bar 13 become sufficiently smaller than those of the positive electrode terminal P1 and the negative electrode terminal N1, and heating of the snubber capacitor 14 from the first bus bar 12 and the second bus bar 13 is small.

Regarding the snubber capacitor 14, in order to suppress a surge voltage at the time of turn-off, using a chip-type ceramic capacitor, a thin film capacitor, a film capacitor, or the like, as a capacitor having good high-frequency characteristics, and having high heat resistance for withstanding a high-temperature operation of the power semiconductor module 1 is desirable.

In addition, the first bus bar 12 and the second bus bar 13 may not be bus bars as long as the first bus bar 12 and the second bus bar 13 can electrically connect the positive electrode terminal P1 and the negative electrode terminal N1 to the snubber capacitor 14. For example, a configuration in which a first wiring pattern and a second wiring pattern are disposed on an insulating substrate, and a snubber capacitor 14 is connected between one side of the first wiring pattern and one side of the second wiring pattern, and the other side of the first wiring pattern and the positive electrode terminal P1 are connected, and the other side of the second wiring pattern and the negative electrode terminal N1 are connected or the like may be employed.

FIG. 2 is an enlarged view of a mounting part of the snubber capacitor 14 illustrated in FIG. 1.

As illustrated in FIG. 2, in this example, a connection part of the snubber capacitor 14 and the first bus bar 12 and a connection part of the snubber capacitor 14 and the second bus bar 13 are disposed on the same principal face (a lower face in FIG. 2) as that of the snubber capacitor 14.

In the present invention, in order to connect the snubber capacitor 14 between the positive electrode terminal P1 and the negative electrode terminal N1, the first bus bar 12 and the second bus bar 13 need to be three-dimensionally wired. For this reason, compared to a case in which a capacitor is two-dimensionally bonded on a print substrate, a thermal stress occurring in a solder bonding part between the snubber capacitor 14 and the bus bar may increase. For example, in FIG. 2, in a case in which the second bus bar 13 is thermally expanded in a vertical direction 17, a thermal stress (compressive stress) 18 occurs in the solder bonding part.

Thus, in order to reduce this thermal stress 18, a bending part 16 is disposed in the second bus bar 13. In a case in which the second bus bar 13 is thermally expanded, with this bending part 16 being transformed in a horizontal direction 19, this thermal stress 18 is reduced, and cracks in the solder bonding part can be prevented. In order to reduce a thermal stress in the horizontal direction of the bus bar, the bending part 16 may be disposed in the horizontal direction of the bus bar or may be disposed in the first bus bar 12 in accordance with the wiring structure of the bus bar.

FIG. 3 is a diagram conceptually illustrating the flow of a current in FIG. 2.

For reduction of a surge voltage at the time of turn-off, it is effective that the wiring inductance of the first bus bar 12, the second bus bar 13, and the snubber capacitor 14 is small as well.

Thus, as illustrated in FIG. 3, by configuring a current direction 21 of the negative electrode terminal N1 and a snubber current direction 45 of a snubber current flowing through the first bus bar 12 and the snubber capacitor 14 disposed parallel to the negative electrode terminal N1, and a current direction 20 of the positive electrode terminal P1 and a snubber current direction 46 of a snubber current flowing through the second bus bar 13 disposed parallel to the positive electrode terminal P1 to be opposite directions, magnetic fluxes generated by the flowing currents are offset, and the wiring inductance of the first bus bar 12, the second bus bar 13, and the snubber capacitor 14 can be reduced.

FIG. 4 is a plan view of the power semiconductor module 1 illustrated in FIG. 1.

As illustrated in FIG. 4, the first bus bar 12 is disposed to branch from the negative electrode terminal N1, and the second bus bar 13 is disposed to branch from the positive electrode terminal P1.

FIG. 5 is an equivalent circuit diagram of a half bridge circuit configured using the power semiconductor module 1 illustrated in FIG. 1.

As illustrated in FIG. 5, between the positive electrode terminal P1 and the negative electrode terminal N1 of the power semiconductor module 1, a DC smoothing capacitor 26 and a DC power supply 24 are connected in parallel outside the module. In addition, between the positive electrode terminal P1 and an AC terminal (first AC terminal) AC1, a load inductance 28 is connected. The snubber capacitor 14 is connected between the positive electrode terminal P1 and the negative electrode terminal N1 inside the module.

Compared to the DC smoothing capacitor 26, by disposing the snubber capacitor 14 at a position close to a bridge configured by the switching elements (SW11 and SW12) of the upper arm and the switching elements (SW21 and SW22) of the lower arm, the wiring inductance 25 of the main circuit for a current flowing through the snubber capacitor 14 at the time of turn-off switching becomes small, and thus a surge voltage at the time of turn-off switching can be reduced.

FIG. 6 is a diagram illustrating a simulation result of a switching waveform of a case in which no snubber capacitor is present in the circuit configuration illustrated in FIG. 5.

In turn-off switching near 81 μs, in accordance with a decrease in a gate voltage VgeL of the lower arm from +17 V of the on-time toward −10 V of the off-time, Ic1+Ic2 that is a sum value of currents flowing through the switching elements of the lower arm (SW21 and SW22) is cut off. A surge voltage generated by the wiring inductance 25 due to di/dt at the time of current cut-off is applied to both ends of the switching elements (SW21 and SW22) of the lower arm in addition to a DC voltage Vcc.

As a result, a surge voltage of 550 V is applied in addition to 1200 V of the DC power supply voltage Vcc, and the collector-to-emitter voltage VceL of the lower arm is caused to spike up to near 1750 V.

FIG. 7 is a diagram illustrating a simulation result of a switching waveform of a case in which the capacitance of the snubber capacitor 14 is 50 nF in the circuit configuration illustrated in FIG. 5.

In turn-off switching near 81 us in FIG. 7, for a current flowing through the snubber capacitor 14 at the time of switching, the wiring inductance 25 of the main circuit decreases, the surge voltage can be reduced, and thus the surge voltage is reduced to 300 V with respect to 550 V of the case in which no snubber capacitor is present as illustrated in FIG. 6.

On the basis of comparison between FIG. 6 and FIG. 7, it can be confirmed that, also for the capacitance of the snubber capacitor 14 in order of several tens of nF to several hundreds of nF that can be mounted in the power semiconductor module 1 according to the present invention, the effect of reduction of the surge voltage at the time of turn-off is sufficiently acquired.

### Example 2

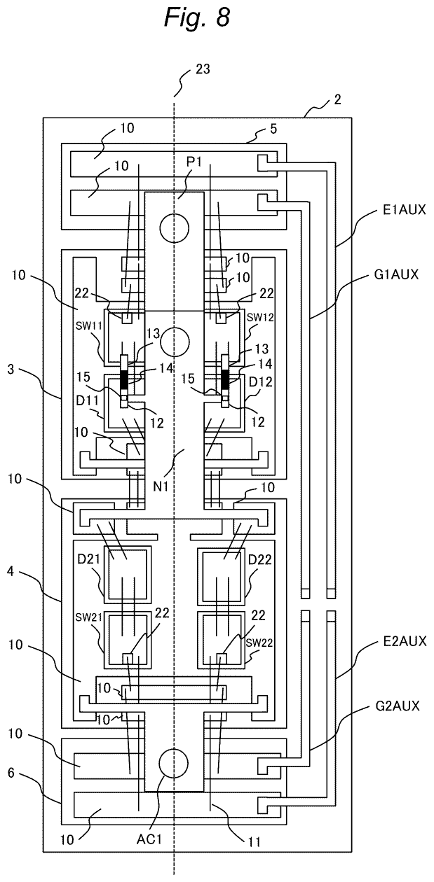

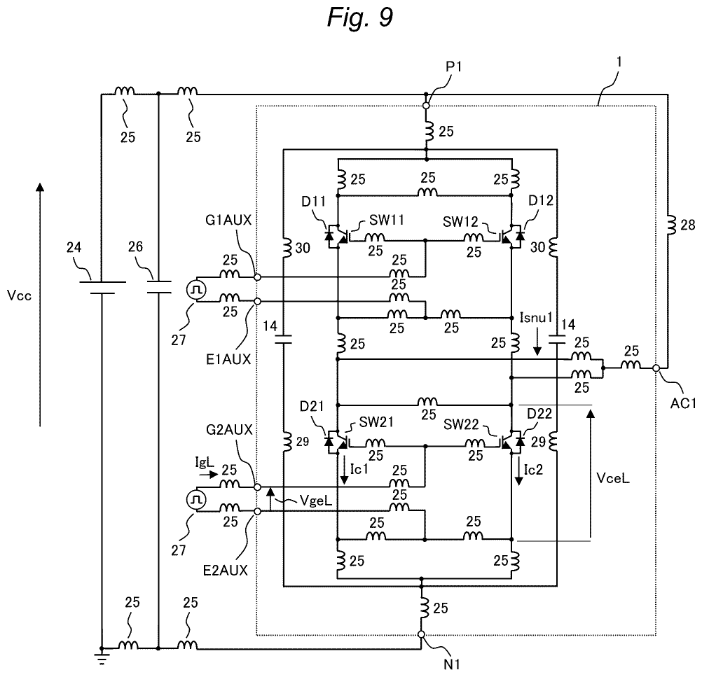

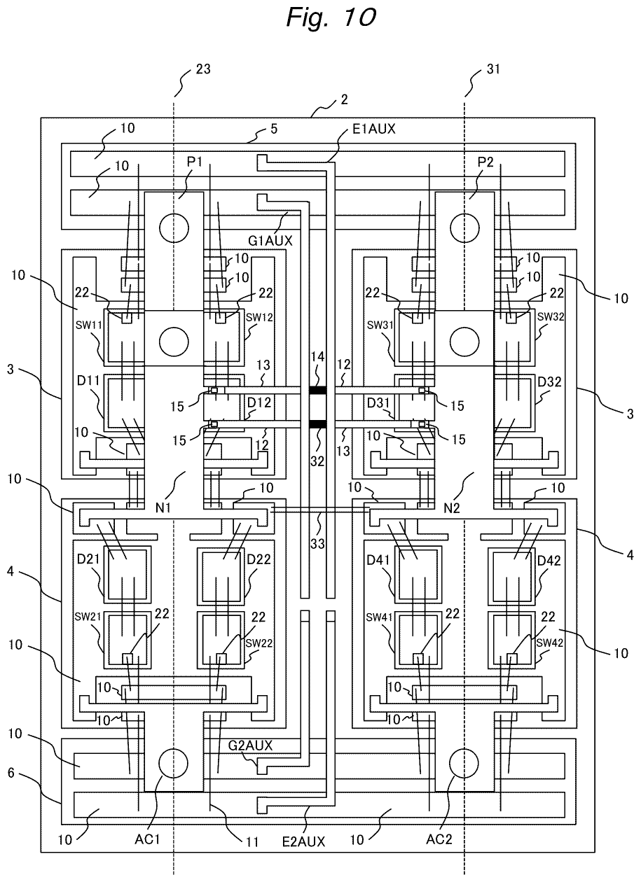

A power semiconductor module according to Example 2 of the present invention will be described with reference to FIGS. 8 and 9. Hereinafter, mainly, points different from Example 1 will be described.

FIG. 8 is a plan view of the power semiconductor module 1 according to this example and corresponds to a modified example of Example 1 (FIG. 4).

As illustrated in FIG. 8, in the power semiconductor module 1 according to this example, two snubber capacitors 14 are symmetrically disposed with a virtual center line 23 of a positive electrode terminal P1 and a negative electrode terminal N1 used as a boundary.

As illustrated in FIG. 4, when a plurality of switching elements are connected in parallel on an insulating substrate 3 or an insulating substrate 4, there is a difference in wiring distances from the snubber capacitor 14 to the respective switching elements, and wiring inductances 25 from the snubber capacitor 14 to respective switching elements may be different from each other among the switching elements connected in parallel.

In this case, effects of voltage drop in the wiring inductance 25 occurring due to a snubber capacitor current are different among the parallel switching elements, and thus an electric potential difference occurs between the parallel switching elements, and a circulation current for resolving the electric potential difference may flow.

This circulation current can be suppressed by disposing the snubber capacitors 14 at positions at which the wiring inductance 25 from respective switching elements connected in parallel are equal. For example, as illustrated in FIG. 8, this circulation current can be suppressed by symmetrically disposing a plurality of snubber capacitors 14 with a virtual center line 23 between the positive electrode terminal P1 and the negative electrode terminal N1 used as a boundary.

FIG. 9 is an equivalent circuit diagram of a half bridge circuit configured using the power semiconductor module 1 illustrated in FIG. 8.

As illustrated in FIG. 8, by symmetrically disposing a plurality of snubber capacitors 14 inside a power semiconductor module 1, as illustrated in FIG. 9, the plurality of snubber capacitors 14 can be configured to be horizontally symmetrical even in an equivalent circuit.

In addition, by symmetrically disposing a plurality of snubber capacitors 14, through parallel connection of the plurality of snubber capacitors 14, synthetic capacitance of the snubber capacitors 14 increases, and the effect of suppressing the surge voltage can be enhanced.

### Example 3

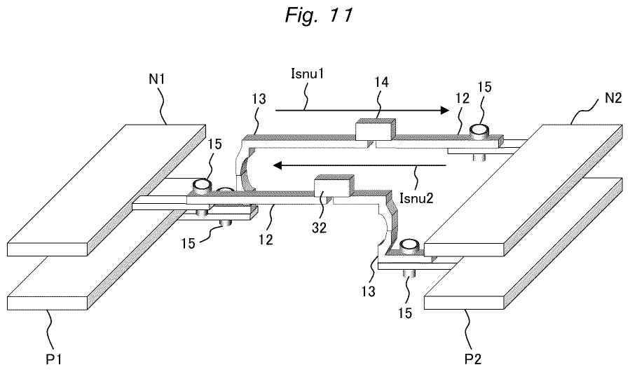

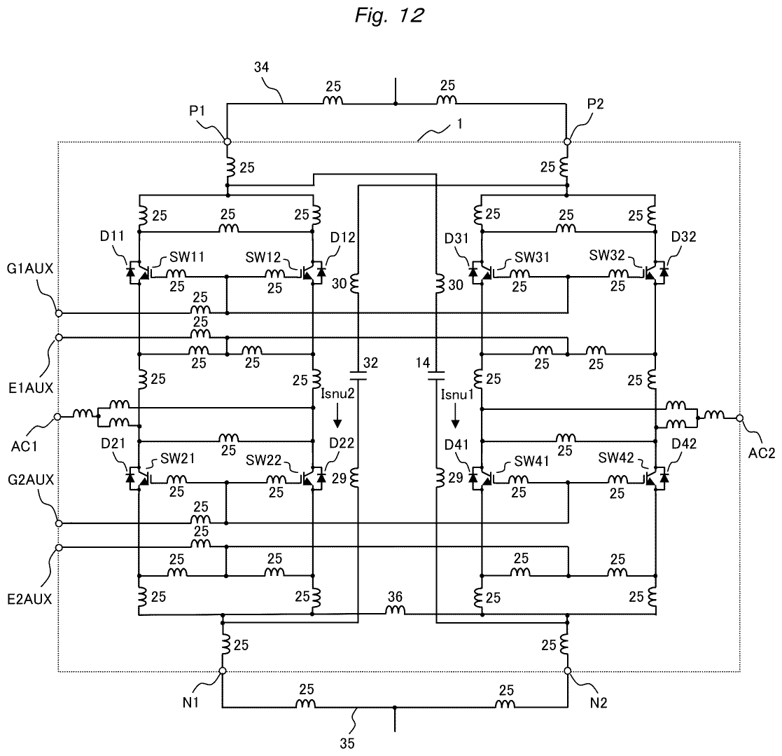

A power semiconductor module according to Example 3 of the present invention will be described with reference to FIGS. 10 and 12. Hereinafter, mainly, points different from Example 1 will be described.

FIG. 10 is a plan view of the power semiconductor module 1 according to this example and corresponds to a modified example of Embodiment 1 (FIG. 4).

As illustrated in FIG. 10, in the power semiconductor module 1 according to this example, a positive electrode terminal has a first positive electrode terminal P1 and a second positive electrode terminal P2, a negative electrode terminal has a first negative electrode terminal N1 and a second negative electrode terminal N2, and, when the power semiconductor module 1 is seen in the plan view, the first positive electrode terminal P1 and at least a part of the first negative electrode terminal N1 are disposed to overlap each other, and the second positive electrode terminal P2 and at least a part of the second negative electrode terminal N2 are disposed to overlap each other.

A snubber capacitor has a first snubber capacitor 14 that is electrically connected between the first positive electrode terminal P1 and the second negative electrode terminal N2 and a second snubber capacitor 32 that is electrically connected between the second positive electrode terminal P2 and the first negative electrode terminal N1.

The first positive electrode terminal P1 and the second positive electrode terminal P2 and the first negative electrode terminal N1 and the second negative electrode terminal N2 are electrically connected using bus bars or the like, which are not shown in the drawing, outside the module. In other words, since the first positive electrode terminal P1 and the second positive electrode terminal P2 and the first negative electrode terminal N1 and the second negative electrode terminal N2 respectively have the same electric potentials, the first snubber capacitor 14 and the second snubber capacitor 32 have a relation of parallel connection.

FIG. 11 is a perspective view of a mounting part of the first snubber capacitor 14 and the second snubber capacitor 32 inside of the power semiconductor module 1 illustrated in FIG. 10.

As illustrated in FIG. 11, by cross-connecting each snubber capacitor between left and right terminals, the snubber capacitor can be further separated apart from the positive electrode terminal and the negative electrode terminal generating heat more than those of Example 1, and a temperature rise of the snubber capacitor can be suppressed.

However, when cross-connection is performed as in FIG. 11, the wiring length of each of the first bus bar 12 and the second bus bar 13 is increased, and the wiring inductance 29 of the first bus bar 12 and the wiring inductance 30 of the second bus bar 13 increase. In order to reduce this wiring inductance, as illustrated in FIG. 11, a current path from the first positive electrode terminal P1 to the second negative electrode terminal N2 via the first snubber capacitor 14 and a current path from the second positive electrode terminal P2 to the first negative electrode terminal N1 via the second snubber capacitor 32 may be configured to be approximately parallel to each other.

By configuring the current paths to be approximately parallel to each other, the direction of a current Isnu1 flowing through the first snubber capacitor 14 and the direction of a current Isnu2 flowing through the second snubber capacitor 32 become opposite directions, and thus magnetic fluxes generated by the currents are offset, and the wiring inductance of the first bus bar 12, the second bus bar 13, the first snubber capacitor 14, and the second snubber capacitor 32 can be reduced.

FIG. 12 is an equivalent circuit diagram of the inside of the power semiconductor module 1 illustrated in FIG. 10.

The first positive electrode terminal P1 and the second positive electrode terminal P2 are electrically connected via a bus bar 34 outside of the module. Similarly, the first negative electrode terminal N1 and the second negative electrode terminal N2 are electrically connected via a bus bar 35 outside of the module. For this reason, as described above, the first snubber capacitor 14 and the second snubber capacitor 32 have a relation of parallel connection.

By performing cross-connection of a snubber capacitor as illustrated in FIG. 12, a single circulation loop path between the snubber capacitor and switching elements of upper and lower arms spans across the left and right insulating substrates. For example, in the case of the first snubber capacitor 14, a single circulation loop path passing through the first snubber capacitor 14, switching elements SW11 and SW12 of an upper arm of the left insulating substrate 3, and switching elements SW21 and SW22 of a lower arm of the left insulating substrate 4 and returning to the first snubber capacitor 14 is formed.

Thus, by adding a wiring connecting the left and right insulating substrates with low inductance, the wiring inductance of this single circulation loop path can be reduced, and thus the effect of suppressing a surge voltage at the time of turn-off switching can be enhanced. As illustrated in FIG. 10, in this example, by disposing a bonding wire 33 connecting emitter electrodes of insulating substrates 4 of left and right lower arms, that is, the first negative electrode terminal N1 and the second negative electrode terminal N2, by using wiring inductance 36 (see FIG. 12) of the bonding wire 33, the emitter electrodes of the insulating substrates 4 of the left and right lower arms are connected with low inductance.

### Example 4

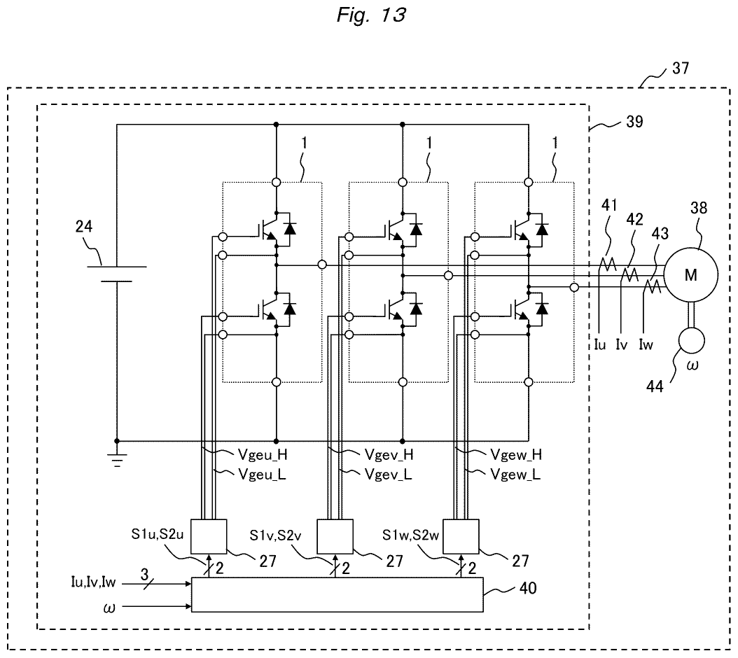

A motor drive system according to Example 4 of the present invention will be described with reference to FIG. 13.

FIG. 13 is a configuration diagram of the motor drive system 37 according to this example.

As illustrated in FIG. 13, the motor drive system 37 according to this example drives a motor 38 using AC power output by a power converting device 39.

The power converting device 39 includes a three-phase inverter main circuit configured by three power semiconductor modules 1 (2-in-1 modules) each including one set of upper and lower arms, a DC power supply 24 connected to a DC side of the three-phase inverter main circuit, a gate drive circuit 27 driving the power semiconductor modules 1, and a controller 40 outputting a PWM signal to the gate drive circuit 27.

As the power semiconductor module 1, any one of the power semiconductor modules according to Example 1 to Example 3 described above is used. A motor 38 is a three-phase AC motor, and each phase of the motor 38 is connected to an AC terminal (for example, “AC1” illustrated in FIG. 1) of the power semiconductor module 1.

The controller 40 calculates two PWM signals (S1i to S2i: i=u, v, and w) for each phase on the basis of three-phase currents (Iu, Iv, and Iw) of the motor 38 detected by current sensors (41, 42, and 43) and the rotation speed (ω) of the motor 38 detected by a speed detector 44 and outputs the calculated PWM signals to the gate drive circuits 27 of respective phases. By switching the power semiconductor module 1 in accordance with a PWM signal by using the gate drive circuit 27, DC power from the DC power supply 24 is converted into three-phase AC power. With this three-phase AC power, the motor 38 is driven.

By applying any one of the power semiconductor modules according to Example 1 to Example 3 described above as the power semiconductor module 1, both a high power density of the power semiconductor module 1 and a low loss due to suppression of a surge voltage at the time of turn-off switching are achieved, and a small size and a low loss of the power converting device 39 can be implemented.

The present invention is not limited to the examples described above, and various modified examples are included therein. For example, the examples described above are described in detail for easy explanation of the present invention and are not necessarily limited to being configured to include all the described components. In addition, a part of the configuration of a certain example can be substituted with the configuration of another example, and the configuration of another example can be added to the configuration of a certain example. In addition, for a part of the configuration of each example, additions, omissions, and substitutions of other components can be performed.

### REFERENCE SIGNS LIST

1 Power semiconductor module
2 Metal base
3 Insulating substrate of upper arm
4 Insulating substrate of lower arm
5 Insulator substrate of upper arm
6 Insulator substrate of lower arm
7 Solder
8 Metal layer
9 Insulating layer
10 Wiring pattern
11 Bonding wire
12 First bus bar
13 Second bus bar
14 (First) Snubber capacitor
15 Screw
16 Bending part
17 Vertical direction
18 (Direction of) Thermal stress
19 Horizontal direction
20 Direction of current flowing though positive electrode terminal P1
21 Direction of current flowing though negative electrode terminal N1
22 Gate electrode
23 Virtual center line of positive electrode terminal P1 and negative electrode terminal N1
24 DC power supply
25 Wiring inductance
26 DC smoothing capacitor
27 Gate drive circuit
28 Load inductance
29 Wiring inductance of first bus bar 12
30 Wiring inductance of second bus bar 13
31 Virtual center line of positive electrode terminal P2 and negative electrode terminal N2
32 (Second) Snubber capacitor
33 Bonding wire connecting emitter electrodes of insulating substrates of left and right lower arms
34 Bus bar connecting first positive electrode terminal P1 and second positive electrode terminal P2
35 Bus bar connecting first negative electrode terminal N1 and second negative electrode terminal N2
36 Wiring inductance of bonding wire connecting emitter electrodes of insulating substrates of left and right lower arms
37 Motor drive system
38 Motor
39 Power converting device
40 Controller
41, 42, 43 Current sensor
44 Speed detector
45 Snubber current direction
46 Snubber current direction
47 Gel
SW11, SW12, SW21, SW22, SW31, SW32, SW41, SW42 Switching elements
D11, D12, D21, D22, D31, D32, D41, D42 Diode
P1 (First) Positive electrode terminal
P2 (Second) Positive electrode terminal
N1 (First) Negative electrode terminal
N2 (Second) Negative electrode terminal
AC1 (First) AC terminal
AC2 (Second) AC terminal
G1AUX Gate auxiliary terminal of upper arm
G2AUX Gate auxiliary terminal of lower arm
E1AUX Emitter auxiliary terminal of upper arm
E2AUX Emitter auxiliary terminal of lower arm
Vcc DC power supply voltage
Ic1 Current flowing though SW21
Ic2 Current flowing though SW22
VceL Collector-to-emitter voltage of lower arm
VgeL Gate-to-emitter voltage of lower arm
Isnu1 Current flowing though first snubber capacitor 14
Isnu2 Current flowing though second snubber capacitor 32

1. A power semiconductor module comprising:
a positive electrode terminal;
a negative electrode terminal of which at least a part is disposed to overlap the positive electrode terminal in a plan view;
a first wiring branching from the positive electrode terminal;
a second wiring branching from the negative electrode terminal; and
a snubber capacitor disposed outside of a position at which the positive electrode terminal and the negative electrode terminal overlap each other in the plan view and connected through the first wiring and the second wiring.

2. The power semiconductor module according to claim 1, wherein the first wiring and the second wiring are wiring patterns disposed on a bus bar or an insulating substrate.

3. The power semiconductor module according to claim 1, wherein the positive electrode terminal and the first wiring and the negative electrode terminal and the second wiring are connected using screws.

4. The power semiconductor module according to claim 1, wherein a connection part of the snubber capacitor and the first wiring and a connection part of the snubber capacitor and the second wiring are disposed on the same principal face as that of the snubber capacitor.

5. The power semiconductor module according to claim 1, wherein a bending part is included in at least one of the first wiring and the second wiring.

6. The power semiconductor module according to claim 1,
wherein directions of current flowing through the positive electrode terminal and the first wiring are opposite directions, and
wherein directions of current flowing through the negative electrode terminal and the second wiring are opposite directions.

7. The power semiconductor module according to claim 6,
wherein the first wiring has a part that is approximately parallel to the positive electrode terminal, and
wherein the second wiring has a part that is approximately parallel to the negative electrode terminal.

8. The power semiconductor module according to claim 1, further comprising a plurality of snubber capacitors,
wherein the plurality of snubber capacitors are symmetrically disposed with a virtual center line of the positive electrode terminal or the negative electrode terminal used as a boundary.

9. The power semiconductor module according to claim 1,
wherein the positive electrode terminal has a first positive electrode terminal and a second positive electrode terminal,
wherein the negative electrode terminal has a first negative electrode terminal and a second negative electrode terminal,
wherein the first positive electrode terminal and at least a part of the first negative electrode terminal are disposed to overlap each other in the plan view, and
wherein the second positive electrode terminal and at least a part of the second negative electrode terminal are disposed to overlap each other.

10. The power semiconductor module according to claim 9, wherein the snubber capacitor has a first snubber capacitor that is electrically connected between the first positive electrode terminal and the second negative electrode terminal and a second snubber capacitor that is electrically connected between the second positive electrode terminal and the first negative electrode terminal.

11. The power semiconductor module according to claim 10, wherein a current path from the first positive electrode terminal to the second negative electrode terminal via the first snubber capacitor and a current path from the second positive electrode terminal to the first negative electrode terminal via the second snubber capacitor have a part that is approximately parallel to each other.

12. The power semiconductor module according to claim 9, wherein a wiring connecting the first negative electrode terminal and the second negative electrode terminal is included inside the power semiconductor module.

13. A motor drive system using the power semiconductor module according to claim 1.
